SEQUENCE LISTING (1 sequence)

SEQ ID NO: 1 - protein, 829 aa, Bacillus acidopullulyticus
DSTSTEVIVHYHRFDSNYANWDLWMWPYQPVNGNGAAYEFSGKDDFGVKADVQVPGDDTQVGLIVRTNDWSQKNTSDDLHIDLTKGHEIWIVQGDPNIYYNLSDAQAAATPKVSNAYLDNEKTVLAKLTNPMTLSDGSSGFTVTDKTTGEQIPVTAATNANSASSSEQTDLVQLTLASAPDVSHTIQVGAAGYEAVNLIPRNVLNLPRYYYSGNDLGNVYSNKATAFRVWAPTASDVQLLLYNSETGPVTKQLEMQKSDNGTWKLKVPGNLKNWYYLYQVTVNGKTQTAVDPYVRAISVNATRGMIVDLEDTNPPGWKEDHQQTPANPVDEVIYEVHVRDFSIDANSGMKNKGKYLAFTEHGTKGPDNVKTGIDSLKELGINAVQLQPIEEFNSIDETQPNMYNWGYDPRNYNVPEGAYATTPEGTARITQLKQLIQSIHKDRIAINMDVVYNHTFNVGVSDFDKIVPQYYYRTDSAGNYTNGSGVGNEIATERPMVQKFVLDSVKYWVKEYHIDGFRFDLMALLGKDTMAKISKELHAINPGIVLYGEPWTGGTSGLSSDQLVTKGQQKGLGIGVFNDNIRNGLDGNVFDKSAQGFATGDPNQVNVIKNGVMGSISDFTSAPSETINYVTSHDNMTLWDKISASNPNDTQADRIKMDELAQAVVFTSQGVPFMQGGEEMLRTKGGNDNSYNAGDSVNQFDWSRKAQFENVFDYYSWLIHLRDNHPAFRMTTADQIKQNLTFLDSPTNTVAFELKNHANHDKWKNIIVMYNPNKTAQTLTLPSGNWTIVGLGNQVGEKSLGHVNGTVEVPALSTIILHQGTSEDVIDQN

(19) United States
(12) Patent Application Publication
(10) Pub. No.: US 2011/0195149 A1
(43) Pub. Date: Aug. 11, 2011

(54) Brewing process

(75) Inventors: Stefan Kreisz, Roedvore (DK); Anne Mette Frederiksen, Copenhagen (DK)

(73) Assignee: Novozymes A/S, Bagsvaerd (DK)

(21) Appl. No.: 13/120,693

(22) PCT Filed: Oct. 8, 2009
(86) PCT No.: PCT/EP2009/063098

§ 371 Date: Mar. 24, 2011

Related U.S. Application Data
(60) Provisional application No. 61/106,187, filed on Oct. 17, 2008.

(30) Foreign Application Priority Data
Oct. 15, 2008 (EP) 08166635.6

(51) Int. Cl. C12C 7/00; C12C 11/00

(52) U.S. Cl. 426/13; 435/93

(57) ABSTRACT

A process for producing a wort comprising the steps of mixing a grist with water, adding a debranching enzyme, wherein said debranching enzyme has above 60% enzyme activity, at 64° C., for a period of 10 minutes, at pH 5.0, resting said mixture at 58-68° C. for a period of 10-40 minutes, resting said mixture at 72-80° C., for a period of 5-20 minutes, and separating the wort from solid components.

### FIELD OF THE INVENTION

The present invention relates to processes comprising shortened mashing regimes for production of a brewer's wort and for the production of beer.

### BACKGROUND OF THE INVENTION

Brewing processes are well-known in the art, and generally involve the steps of malting, mashing, and fermentation. Mashing is the process of converting starch from malted grains and solid adjuncts into fermentable and unfermentable sugars to produce a wort of desired composition. The mashing process is conducted over a period of time at various temperatures in order to activate the endogenous enzymes responsible for the degradation of proteins and carbohydrates. By far the most important change brought about in mashing is the conversion of starch molecules into fermentable sugars however the enzymes which bring about this conversion have different temperature optimum and it is necessary to heat the mash to different temperatures, at which the enzymes work optimally.

At a given temperature the enzymes need a certain time span to react properly, this period is often referred to as an enzyme rest e.g. (saccharification rest). These enzyme rests are time consuming and tend to create bottle necks in the brewing process thus for the most efficiency and cost benefit mashing process the enzyme rest period should be as short as possible.

However, the effectiveness of starch breakdown during mashing depends on e.g. the time and temperature of the enzyme rests, the starch (type, degree of malt etc.) and the levels and activity of starch degrading enzymes in the mash. When the starch has reached gelatinization temperature, which is the temperature where the starch is fully accessible to the amylases usually around 58-62° C. the starch hydrolysis progresses very quickly. At this temperature alpha-amylase is relatively stable whereas beta-amylase and debranching enzymes, such as pullulanases are more heat labile and begin to inactivate. Therefore, mashing process generally applies a controlled stepwise increase in temperature, where each step favors one enzymatic action over the other, eventually degrading proteins, cell walls and starch. Consequently, mashing is a very time consuming step in brewing. Most mashing processes consume at least 90 minutes and includes rests around 45-52° C., around 62° C. and around 72° C.

The combination of temperature and length of the enzymes rests influences the ratio of fermentable to unfermentable sugars in the wort and thus both the fermentability of the wort and the final flavour and aroma of the fermented beverage.

WO2005121305 describes a mashing process wherein a combination of the enzymes alpha-amylase, glycoamylase and isoamylase is added for producing a wort which can be fermented to a low carbonhydrate beverage.

WO2007144393 describes a process for producing wort wherein pullulanase is added to the mash.

Gregor at al. (Journal of Cereal Science, Vol. 29, page 161-169, 1999) describes the interaction during the mashing process of the starch converting enzymes alpha-amylase, beta-amylase and limit dextrinase.

Odibo and Obi 1989, Mircen Journal, 5 (2) 187-192 discloses a method for preparing a mash from sorghum malt comprising the addition of thermostable microbial pullulanase. The total mashing time was 126 minutes.

There exists a need for improved processes whereby the mashing time is as short as possible for efficiency and cost benefits.

### SUMMARY OF THE INVENTION

The inventors have surprisingly found that by adding a thermostable debranching enzyme the enzyme rests during mashing can be shorted or eliminated thereby making the process of producing wort remarkably faster. Accordingly, the invention provides

a process for producing a wort comprising the steps of
a) mixing a grist with water,
b) adding a debranching enzyme, wherein said debranching enzyme has above 60% enzyme activity, at 64° C., for a period of 10 minutes, at pH 5.0,
c) resting said mixture at 58-68° C. for a period of 10-40 minutes,
d) resting said mixture at 72-80° C., for a period of 5-20 minutes, and
e) separating the wort from solid components.

The invention further concerns a wort or a beer produced by the process of the invention. The invention also concerns the use of an enzyme according to the invention in any of the processes according to the invention.

In addition to shortening the mashing process the enzymes according to the invention could also be added to a process for producing a wort with high amount of fermentable sugars.

Thus the invention also concerns a process of producing a wort, comprising the steps of
a) mixing a grist with water, wherein the grist comprises at least 50% malt,
b) adding a debranching enzyme, wherein said debranching enzyme has above 60% enzyme activity, at 64° C., for a period of 10 minutes, at pH 5.0, and resting said mixture at 58-68° C.,
c) increasing the temperature to 72-80° C., and resting said mixture at 72-80° C., and
d) separating the wort from the solid components,
   wherein the amount of fermentable sugar in the wort is more than 75% of the soluble carbohydrates.

The invention further concerns a wort made from 50-100% malt, and 0-50% starch containing adjunct where the amount of fermentable sugar are higher than 75% of the soluble carbohydrates or a wort produced by a process according to the invention, wherein the amount fermentable sugars in the wort is at least 75% of the soluble carbohydrates.

### DEFINITIONS

Throughout this disclosure, various terms that are generally understood by those of ordinary skill in the arts, are used. Some terms are described more broadly in “detailed description”. A short definition of some of the frequent used terms is given below.

In this context an “enzyme rests” or simply “rests” or “resting” is the time period or time span for which the mash, which is the mixture of grist and water and optionally adjuncts are kept at a certain temperature, for the enzymes (endogenous and optionally exogenous) to work on the starch.

As used herein the term “grist” is understood as the carbohydrate containing material that is the basis for beer production, e.g., the barley malt and the adjunct.

The term “malt” is understood as any malted cereal grain, in particular barley.

The term “wort” is understood as the unfermented liquor run-off following extracting the grist during mashing.

The term “beer” is understood as fermented wort.

The term “identity” is the relatedness between two amino acid sequences or between two nucleotide sequences. For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the degree of identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment)

### DETAILED DESCRIPTION OF THE INVENTION

In a brewing process the mashing conditions, such as temperature, pH and the amount of enzymes and the time period these enzymes are working on the starch (e.g. enzyme rest) have great implications on the fermented outcome. In beer brewing the type of beer produced highly depends on the length and temperature of the enzyme rests.

### Mashing

The inventors have now surprisingly found that by using a thermostable debranching enzyme the enzyme rests in mashing could be shortened or eliminated. Thus a first aspect of the invention concerns a process of making wort comprising the steps of:

A process for producing a wort comprising the steps of
a) mixing a grist with water,
b) adding a debranching enzyme, wherein said debranching enzyme has above 60% enzyme activity, at 64° C., for a period of 10 minutes, at pH 5.0,
c) resting said mixture at 58-68° C. for a period of 10-40 minutes,
d) resting said mixture at 72-80° C., for a period of 5-20 minutes, and
e) separating the wort from solid components.

In one embodiment the temperature is increased from step c) to step d) within 20 minutes.

In another embodiment steps b)-d) is completed within 30-70 minutes.

### Temperature Profile

The inventors have found that adding a thermostable debranching enzyme reduces the length of the enzyme rests during mashing and/or eliminate the amount of enzyme rests needed thereby reducing the overall mashing time considerably.

In the present invention the temperature of step c) of the process according to the first aspect of the invention is preferably performed between 58-68° C., such as between 59-67° C., such as between 60-66° C., such as between 61-65° C., such as between 62-64° C., such as between 63-64° C., preferably the temperature is between 63-65° C., such as 64° C.

The mixture, which is grist mixed with water, is rested at a temperature selected from the above mentioned temperature intervals for a period of 10-40 minutes, such as 11-39 minutes, such as 12-38 minutes, such as 13-37 minutes, such as 14-36 minutes, such as 15-35 minutes, such as 16-34 minutes, such as 17-33 minutes, such as 18-32 minutes, such as 19-31 minutes, such as 20-30 minutes, such as 21-29 minutes, such as 22-28 minutes, such as 23-27 minutes, such as 24-26 minutes, such as 25-26 minutes. In a preferred embodiment the mixture is rested 15-35 minutes, in a more preferred embodiment the mixture is rested 20-30 minutes, in an even more preferred embodiment the mixture is rested 25-30 minutes, in a most preferred embodiment the mixture is rested for 15-30 minutes.

The temperature from step c) to step d) in the process according the first aspect of the invention is preferably increased by 1° C./min. Thus in one embodiment the temperature is increased from step c) to step d) within 20 minutes, such as within 19 minutes, such as within than 18 minutes, such as within 17 minutes, such as within 16 minutes, such as within 15 such as within 14 minutes, such as within 13 minutes, such as within 12 minutes, such as within 11 minutes, such as within 10 minutes, such as within 9 minutes, such as within 8 minutes, such as within 7 minutes, such as within 6 minutes, such as within 5 minutes, such as within 4 minutes.

In step d) the mixture is rested at a temperature between 72-80° C., such as 73-79° C., such as 74-78° C., such as 75-78° C., such as 76-78° C., preferably such as 77-78° C., for a period of 5-20 minutes, such as a period of 6-19 minutes, such as a period of 7-18 minutes, such as a period of 8-17 minutes, such as a period of 9-16 minutes, such as a period of 10-15 minutes, such as a period of 11-14 minutes, such as a period of 12-13 minutes, such as a period of 10-20 minutes, preferably the temperature is rested for a period of 10-15 minutes.

The mashing process could be divided in three parts; mashing in, where the milled grist are filled in a container and mixed with water, mashing where enzymes both endogenous and exogenous supplied are degrading the starch, and mashing out where the temperature is raised and the mixture may be transferred to a lauter tun.

Thus in one object of the invention the mashing of the process according to a first aspect of the invention, which is step b)-d) is completed within 30-70 minutes, such as within 31-69 minutes, such as within 32-67 minutes, such as within 33-66 minutes, such as within 34-65 minutes, such as within 35-64 minutes, such as within 36-63 minutes, such as within 37-62 minutes, such as within 38-61 minutes, such as within 39-60 minutes, such as within 40-59 minutes, such as within 41-58 minutes, such as within 42-57 minutes, such as within 43-56 minutes, such as within 44-55 minutes, such as within 45-54 minutes, such as within 46-53 minutes, such as within 47-52 minutes, such as within 48-51 minutes, such as within 49-50 minutes. In a particularly preferred embodiment the mashing is completed within 70 minutes, more preferably within 60 minutes, more preferably within 50 minutes, even more preferably within 40 minutes or more preferably within 30 minutes.

Thus in this context the mashing time comprises all the enzymes rests and all heating steps, such as all the steps b)-d) of the processes of producing a wort according to the invention is completed within this the period defined above.

In a certain aspect the process according to a first aspect of the invention is completed within 30-70 minutes. That is all the steps a)-e) is completed within 30-70 minutes, such as 40-60 minutes such as within 60 minutes, such as within 50 minutes and such as within 45 minutes.

Thus according to a particular aspect of the present invention the rest at 45-52° C. is not needed.

In this context the time consumed in the mashing process is the same as the total mashing time and the time needed to complete all mashing steps of the processes according to the invention, e.g. steps b)-d). Mashing profile, mashing, mashing regime, mashing time and mashing process are used interchangeably.

### Thermostable

In this context a thermostable enzyme is an enzyme having above 60% enzyme activity after 10 min, at 64° C. and at pH level 5.

In one embodiment the enzyme activity is above 60%, such as above 61%, such as above 62%, such as above 63%, such as above 64%, such as above 65%, such as above 66%, such as above 67%, such as above 68%, such as above 69%, such as above 70%, such as above 71%, such as above 72%, such as above 73%, such as above 74%, such as above 75%, such as above 76%, such as above 77%, such as above 78%, such as above 79%, such as above 80%, such as above 81%, such as above 82%, such as above 83%, such as above 84%, such as above 85%, such as above 86%, such as above 87%, such as above 88%, such as above 89%, such as above 90%, such as above 91%, such as above 92%, such as above 93%, such as above 94%, such as above 95%, such as above 96%, such as above 97%, such as above 98%, such as above 99% and even 100% at 64° C., for a period of 10 minutes, at pH 5.0.

In a particular embodiment of the invention the enzyme has a minimum of 80% of activity after 10 min in mash at 64° C. a pH level of 5.6-6.2, such as above 85%, such as above 90% such as above 95%, or even 100%. It is to be noted that during mashing the pH of the mash ranges between 5.6-6.2. More particularly, it ranges between 5.6 to 5.8.

In another embodiment the enzyme has as a minimum of 80% of activity after 10 min at gelatinization temperature of barley malt, such as above 85%, such as above 90% such as above 95%, or even 100%.

### Grist

According to the invention the grist may comprise any starch derivable from any plant and plant part, including tubers, roots, stems, leaves and seeds. Preferably the grist comprises grain, such as grain from barley, wheat, rye, oat, corn, rice, milo, millet and sorghum, and more preferably, at least 50%, such as at least 60%, such as at least 70%, such as at least 80%, such as at least 90% or even 100% (w/w) of the grist of the wort is derived from grain.

The grist according to one aspect of the invention comprises starch containing malted grain and/or adjunct. The grist may preferably comprise from 0% to 100%, preferably from 20% to 100%, preferably from 30% to 100%, more preferably from 40% to 100%, even more preferably from 50% to 100%, yet more preferably from 60% to 100%, such as from 70% to 100%, such as from 80% to 100% or even most preferably from 90% to 100% malted grain. In a particular embodiment the grist comprises at least 50% malted grain, e.g., malted barley, and approximately 50% adjunct, e.g., unmalted grain, such as unmalted barley, in another embodiment the grist comprises at least 60% malted grain, in yet another embodiment the grist comprises at least 70% malted grain, in a particular embodiment the grist comprises at least 80% malted grain, or even more preferably the grist comprises at least 90% malted grain or even more preferably the grist comprises at least 95% malted grain and in certain preferred embodiment the grist comprises 100% malted grain. 100% malted is referred to in the present context as “all malt”. Thus all malt mash is a mash comprising 100% malted grain. The grain used according to the invention may be any grain, and preferably malted grain selected from malted barley, wheat, rye, sorghum, millet, corn, and rice, and most preferably malted barley. In one embodiment of the invention, pre-gelatinized starch is used, such as pre-gelatinized starch from barley, wheat, rye, sorghum, millet, corn, and rice.

The grains used in the process according to the invention may be “modified” by modified means the extend to which starch molecules in the grain consist of simple chains of sugar molecules versus branched chains, a fully modified grain contains only simple chain starch molecules. A grain not fully modified requires mashing in multiple steps in order for the debranching enzymes to work on the branches. Thus one aspect of the invention the grains comprises well modified malted grains.

### Malt

Malting is a process of germination of cereal grains which are usually initiated by soaking the grains in water. The process can be haltered by dry heating with hot air. Thus the term “malt” is understood as any malted cereal grain. The malted grain used according to the invention may be any malted grain, and preferably malted grain selected from malted barley, wheat, rye, sorghum, millet, corn, and rice, and most preferably malted barley.

A good quality of malt will provide the brewer with high levels of extract and produce a wort which is easily fermented by the yeast.

Thus in one embodiment of the invention the start material is an all malt mash, which in this context are 100% malted grains.

### Adjunct

Adjunct is understood as the part of the grist which is not malted grains. The adjunct may comprise any starch rich plant material, e.g., unmalted grain, such as barley, rice, corn, wheat, rye, sorghum and readily fermentable sugar and/or syrup. The adjunct used in the process of the first aspect may be obtained from tubers, roots, stems, leaves, legumes, cereals and/or whole grain. The adjunct may comprise raw and/or refined starch and/or sugar containing material derived from plants like wheat, rye, oat, corn, rice, milo, millet, sorghum, potato, sweet potato, cassava, tapioca, sago, banana, sugar beet and/or sugar cane. Preferably, the adjunct comprises unmalted grain, e.g., unmalted grain selected from the list consisting of barley, wheat, rye, sorghum, millet, corn, and rice, and most preferably unmalted barley.

### RDF

In one embodiment of the invention a thermostable debranching enzyme according to the invention is added in a process for producing a wort, wherein the start material is grist with at least 50% malt and the fermentable sugars in the wort produced is at least 75% fermentable sugars.

Thus another aspect of the invention concerns a process comprising the steps of
a) mixing a grist with water, wherein the grist comprises at least 50% malt,
b) adding a debranching enzyme, wherein said debranching enzyme has above 60% enzyme activity, at 64° C., for a period of 10 minutes, at pH 5.0, and resting said mixture at 58-68° C.,
c) increasing the temperature to 72-80° C., and resting said mixture at 72-80° C., and
d) separating the wort from the solid components,
   wherein the amount of fermentable sugar in the wort is more than 75% of the soluble carbohydrates.

### Fermentable and Unfermentable Sugars

During the mashing cycle the starch is first solubilised and then a portion of the starch molecules are hydrolyzed into non-fermentable dextrins and to low molecular weight sugars, such as glucose, maltose and maltotriose, which brewers yeast can ferment into ethanol. The non-fermentable or limit dextrin fraction is sugars with a higher degree of polymerisation (DP) than maltotriose, which is the DP4s and higher. During the mashing process the dextrin is hydrolyzed into fermentable sugars by beta-amylase which sequentially removes units of maltose from the non-reducing end of the dextrins. However, the (1→6)-α branch points are resistant to attack by the amylases and these branch point needed to by hydrolysed by debranching enzymes (limit dextrin), such as pullulanase, limit dextranase and isoamylase.

DP is the degree of polymerisation, herein used for average number of glucose units in polymers in a polysaccharide hydrolysate. Thus DP1-3 sugar is according to the invention fermentable sugars which may be glucose (DP1), maltose (DP2) or maltotriose (DP3), whereas e.g. dextrins (DP4) is unfermentable (or non fermentable) sugar.

RDF (Real degree of fermentation) is calculated as RDF %=100*(OE % P−ER %)/OE % P whereas OE means Original Extract in % P and ER means Real Extract % P measured by a densitometer (Analytica EBC reference).

According to the invention the amount of fermentable sugar in the wort is more than 75% of the soluble carbohydrates, such as at least 76%, such as at least 77%, such as at least 78%, such as at least 79%, such as at least 80%, such as at least 81%, such as at least 82%, such as at least 83%, such as at least 84%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99%, such as at least 100%.

Some breweries add brewery syrup, e.g. high maltose, brewing syrup to the wort kettle which may increase the amount of fermentable sugars. However, though brewing syrup may be added according to the invention this is not necessary for increasing the amount of fermentable sugars or RDF.

During the mashing process starch is converted to a wort comprising fermentable and unfermentable sugars. According to the invention the mashing process can be shortened considerably and enables the breweries to use very simple mashing profiles without reducing the fermentability in the wort. As an example a mashing step at 45-52° C. is no longer needed for producing a wort wherein the amount of fermentable sugar in the wort is more than 75% of the soluble carbohydrates.

The inventors have further found that the thermostable debranching enzymes according to the inventions could be used in a process for producing a wort where the amount of fermentable sugar in the wort is more than 75% of the soluble carbohydrates. wherein the process comprises the steps of
a) mixing a grist with water, wherein the grist comprises at least 50% malt
b) adding a thermostable debranching enzyme
c) resting said mixture at 58-68° C. for a period of 10-40 minutes,
d) increasing the temperature to 72-80° C.,
e) resting said mixture at 72-80° C., for a period of 5-20 minutes, and
f) separating the wort from the solid components.
   wherein the amount of fermentable sugar in the wort is more than 75% of the soluble carbohydrates.

Importantly, the processes according to the invention concerns reducing the mashing process by reducing or eliminating the time needed for enzyme rests and in addition producing a wort comprising high amount of fermentable sugars.

Thus according to the invention shortening of the mashing time does not reduce the fermentability of the wort, that is the amount of fermentable sugars in the wort is high compared to the amount of unfermentable sugars.

In a particularly preferred embodiment of the invention the process produces a wort with high amount of maltose compared to glucose. This is favourable because it prevents osmotic pressure on the yeast and regulates the ester production and therefore the flavour and aroma profile of the final beer.

Thus another embodiment of the invention concerns a process, wherein the ratio of maltose:glucose in the wort is higher than 2:1, such as higher than 2.5:1, such as higher than 3:1, preferably higher than 3.2:1, preferably higher than 3.3:1, preferably higher than 3.4:1, preferably higher than 3.5:1 in a particular preferred embodiment the ratio of maltose:glucose in the wort is higher than 3.3:1.

In another embodiment the invention concerns a wort made from 50-100% malt, and 0-50% starch containing adjunct where the amount of fermentable sugar are higher than 75% of the soluble carbohydrates, preferably higher than 80%, and where the maltose:glucose ratio is higher than 2.5:1 preferably higher than 3.3:1.

Yet another embodiment concerns a wort produced by a process of the invention, wherein the fermentable sugars in the wort is at least 75% of the soluble carbohydrate.

### Debranching Enzymes

In a preferred embodiment of the invention, a pullulanase (E.C. 3.2.1.41) enzyme activity is exogenously supplied and present in the mash. The pullulanase may be added to the mash ingredients, e.g., the water and/or the grist before, during or after forming the mash. A further enzyme may be added to the mash, said enzyme being selected from the group consisting of, alpha-amylase (E.C. 3.2.1.1) and/or a glucoamylase (E.C. 3.2.1.3), isoamylase, protease, cellulase, beta-glucanase, xylanase, laccase, xylanase, lipase, phospholipolase, phytase, phytin and esterase.

However, the inventors surprisingly found that the processes according to the invention e.g. the short mashing can be performed with only the debranching enzyme according to the invention. Thus in one aspect of the invention only the debranching enzyme is added to the mash.

Debranching enzyme include according to the present invention isoamylases and pullulanases. Debranching enzymes, which attack amylopectin are divided into two classes: Isoamylases (E.C. 3.2.1.68) and pullulanases (E.C. 3.2.1.41), respectively. Isoamylase hydrolyses alpha-1,6-D-glucosidic branch linkages in amylopectin and beta-limit dextrins and can be distinguished from pullulanases by the inability of isoamylase to attack pullulan, and by limited action on alpha-limit dextrins.

### Pullulanase (E.C. 3.2.1.41)

Most preferably the pullulanase is derived from Bacillus acidopullulyticus. A preferred pullulanase enzyme to be used in the processes and/or compositions of the invention is a pullulanase having an amino acid sequence which is at least 50%, such as at least 55%, such as at least 60%, such as at least 65%, such as at least 66%, such as at least 70%, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identical to the sequence shown in SEQ ID NO: 1; in particular when aligned using the Program Needle using Matrix: BLOSUM62; Gap initiation penalty: 10.0; Gap extension penalty: 0.5; Gapless Identity Matrix.

The pullulanases used in the processes according to the present invention is preferably pullulanase from e.g. Pyrococcus or Bacillus sp, such as Bacillus acidopullulyticus (e.g., the one described in FEMS Microbiol. Letters 115: 97-106) or Bacillus deramificans, or Bacillus naganoencis. The pullulanase may also be an engineered pullulanases from, e.g., a Bacillus strain.

Other pullulanases which is preferably used in the processes according to the invention includes: Bacillus deramificans (U.S. Pat. No. 5,736,375), or the pullulanase may be derived from Pyrococcus Woesei described in PCT/DK91/00219, or the pullulanase may be derived from Fervidobacterium sp. Ven 5 described in PCT/DK92/00079, or the pullulanase may be derived from Thermococcus celer described in PCT/DK95/00097, or the pullulanase may be derived from Pyrodictium abyssei described in PCT/DK95/00211, or the pullulanase may be derived from Fervidobacterium pennavorans described in PCT/DK95/00095, or the pullulanase may be derived from Desulforococcus mucosus described in PCT/DK95/00098.

The pullulanase is added in dosage of 0.1 to 3 PUN/g DM, such as 0.2 to 2.9, such as 0.3 to 2.8, such as 0.3 to 2.7 such as 0.3 to 2.6 such as 0.3 to 2.5 such as 0.3 to 2.4, such as 0.3 to 2.3, such as 0.3 to 2.2, such as 0.3 to 2.1, such as 0.3 to 2.0, such as 0.3 to 1.9, such as 0.3 to 1.8, such as 0.3 to 1.7, such as 0.3 to 1.6, most preferably pullulanase is added in dosage such as 0.3 to 1.5, preferably 0.4 to 1.4, more preferably 0.5 to 1.3, more preferably 0.6 to 1.2, more preferably 0.7 to 1.1, more preferably 0.8 to 1.0, more preferably 0.9 to 1.0. In a particular embodiment of the invention the enzyme is added in 0.3 PUN/g DM, such as 0.4 PUN/g DM, such as 0.5 PUN/g DM in a particularly preferred embodiment of the invention the enzymes dose is not larger than 1 PUN/g DM.

### Isoamylase (E.C. 3.2.1.68)

Another enzyme applied in the processes and/or compositions of the invention may be an alternative debranching enzyme, such as an isoamylase (E.C. 3.2.1.68). The isoamylase may be microbial. Isoamylase hydrolyzes alpha-1,6-D-glucosidic branch linkages in amylopectin and beta-limit dextrins and can be distinguished from pullulanases by the inability of isoamylase to attack pullulan, and by the limited action on alpha-limit dextrins. Isoamylase may be added in effective amounts well known to the person skilled in the art. Isoamylase may be added alone or together with a pullulanase.

### Optional Enzymes

### Alpha-Amylase (EC 3.2.1.1)

An alpha-amylase enzyme may also be exogenous, microbial and added to the processes and/or compositions of the invention. alpha-amylase may be a Bacillus alpha-amylase. Well-known Bacillus alpha-amylases include alpha-amylase derived from a strain of B. licheniformis, B. amyloliquefaciens, and B. stearothermophilus. In the context of the present invention, a contemplated Bacillus alpha-amylase is an alpha-amylase as defined in WO 99/19467 on page 3, line 18 to page 6, line 27. A preferred alpha-amylase has an amino acid sequence having at least 90% identity to SEQ ID NO: 4 in WO 99/19467, such as at least 92%, at least 95%, at least 96%, at least 97%, at least 98%, or particularly at least 99%. Most preferred maltogenic alpha-amylase is SEQ ID NO: 9 or comprise the variants thereof disclosed in WO 99/43794. Contemplated variants and hybrids are described in WO 96/23874, WO 97/41213, and WO 99/19467. Specifically contemplated is an alpha-amylase (E.C. 3.2.1.1) from B. stearothermophilus having the amino acid sequence disclosed as SEQ ID NO: 3 in WO 99/19467 with the mutations: I181*+G182*+N193F. Bacillus alpha-amylases may be added in the amounts of 1.0-1000 NU/kg DS, preferably from 2.0-500 NU/kg DS, preferably 10-200 NU/kg DS. Another particular alpha-amylase to be used in the processes of the invention may be any fungal alpha-amylase, e.g., an alpha-amylase derived from a species within Aspergillus, and preferably from a strain of Aspergillus niger. Especially contemplated are fungal alpha-amylases which exhibit a high identity, i.e., at least 50%, at least 55%, at least 60%, at least 65%, at least 70%, at least 75%, at least 80%, at least 85% or even at least 90% identity to the amino acid sequences shown SEQ ID NO: 1 in WO 2002/038787. Fungal alpha-amylases may be added in an amount of 1-1000 AFAU/kg DS, preferably from 2-500 AFAU/kg DS, preferably 20-100 AFAU/kg DS.

### Glucoamylases (E.C.3.2.1.3)

A glucoamylase which may be used in the processes of the invention may be derived from a microorganism or a plant. Preferred is glucoamylases of fungal origin such as Aspergillus glucoamylases, in particular A. niger G1 or G2 glucoamylase (Boel et al. (1984), EMBO J. 3 (5), p. 1097-1102). Also preferred are variants thereof, such as disclosed in WO92/00381 and WO00/04136; the A. awamori glucoamylase (WO84/02921), A. oryzae (Agric. Biol. Chem. (1991), 55 (4), p. 941-949), or variants or fragments thereof. Preferred glucoamylases include the glucoamylases derived from Aspergillus niger, such as a glucoamylase having 50%, 55%, 60%, 65%, 70%, 75%, 80%, 85% or even 90% homology to the amino acid sequence set forth in WO00/04136 and SEQ ID NO: 13. Also preferred are the glucoamylases derived from Aspergillus oryzae, such as a glucoamylase having 50%, 55%, 60%, 65%, 70%, 75%, 80%, 85% or even 90% homology to the amino acid sequence set forth in WO00/04136 SEQ ID NO:2. Other preferred glucoamylases include Talaromyces glucoamylases, in particular derived from Talaromyces emersonii (WO99/28448), Talaromyces leycettanus (U.S. Pat. No. Re.32,153), Talaromyces duponti, Talaromyces thermophilus (U.S. Pat. No. 4,587,215), Clostridium, in particular C. thermoamylolyticum (EP135,138), and C. thermohydrosulfuricum (WO86/01831). Commercially available compositions comprising glucoamylase include AMG 200L; AMG 300 L; SAN™ SUPER, SAN EXTRA L and AMG™ E (from Novozymes NS); OPTIDEX™ 300 (from Genencor Int.); AMIGASE™ and AMIGASE™ PLUS (from DSM); G-ZYME™ G900, G-ZYME™ and G990 ZR (from Genencor Int.). Glucoamylase activity may be used in the amounts of 0.1 to 100000 AGU/kg DS, preferably in the amounts of 1 to 10000 AGU/kg DS, more preferably in the amounts of 10 to 1000 AGU/kg DS, such as 100 to 500 AGU/kg DS. Glucoamylase may be added in the amount of 0.001 mg to 100000 mg EP/kg DS, preferably in the amount of 0.01 mg to 10000 mg EP/kg DS, more preferably in the amount of 0.1 mg to 1000 mg EP/kg DS, most preferably in the amount of 1 mg to 100 mg EP/kg DS.

### Protease

Suitable proteases include microbial proteases, such as fungal and bacterial proteases. Preferred proteases are acidic proteases, proteases characterized by the ability to hydrolyze proteins under acidic conditions below pH 7.

The proteases are responsible for reducing the overall length of high-molecular-weight proteins to low-molecular-weight proteins in the mash. The low-molecular-weight proteins are a necessity for yeast nutrition and the high-molecular-weight-proteins ensure foam stability. Thus it is well-known to the skilled person that protease should be added in a balanced amount which at the same time allows amble free amino acids for the yeast and leaves enough high-molecular-weight-proteins to stabilize the foam. Proteases may be added in the amounts of 0.1-1000 AU/kg DS, preferably 1-100 AU/kg DS and most preferably 5-25 AU/kg DS.

### Cellulase (E.C. 3.2.1.4)

The cellulase may be of microbial origin, such as derivable from a strain of a filamentous fungus (e.g., Aspergillus, Trichoderma, Humicola, Fusarium). Specific examples of cellulases include the endoglucanase (endoglucanase I) obtainable from H. insolens and further defined by the amino acid sequence of FIG. 14 in WO 91/17244 and the 43 kD H. insolens endoglucanase described in WO 91/17243.

A particular cellulase to be used in the processes of the invention may be an endo-glucanase, such as an endo-1,4-beta-glucanase. Especially contemplated is the beta-glucanase shown in SEQ.ID.NO: 2 in WO 2003/062409 and homologous sequences. Commercially available cellulase preparations which may be used include CELLUCLAST®, CELLUZYME®, CEREFLO® and ULTRAFLO® (available from Novozymes NS), LAMINEX™ and SPEZYME® CP (available from Genencor Int.) and ROHAMENT® 7069 W (available from Röhm, Germany). Beta-glucanases may be added in the amounts of 1.0-10000 BGU/kg DS, preferably from 10-5000 BGU/kg DS, preferably from 50-1000 BGU/kg DS and most preferably from 100-500 BGU/kg DS.

### Separation of Wort

Obtaining the wort from the mash typically includes separating the wort from solid components such as spent grains, i.e., the insoluble grain and husk material forming part of grist. Hot water may be run through the spent grains to rinse out, or sparge, any remaining extract from the grist.

Following the separation of the wort from the spent grains of the grist of any of the aforementioned embodiments of the first aspect, the wort may be used as it is or it may be dewatered to provide concentrated and/or dried wort. The concentrated and/or dried wort may be used as brewing extract, as malt extract flavoring, for non-alcoholic malt beverages, malt vinegar, breakfast cereals, for confectionary etc.

### Production of Beer

In a preferred embodiment, the wort is fermented to produce an alcoholic beverage, preferably a beer, e.g., ale, strong ale, bitter, stout, porter, lager, export beer, malt liquor, barley wine, happoushu, high-alcohol beer, low-alcohol beer, low-calorie beer or light beer. Fermentation of the wort may include pitching the wort with a yeast slurry comprising fresh yeast, i.e., yeast not previously used for the invention or the yeast may be recycled yeast. The yeast applied may be any yeast suitable for beer brewing, especially yeasts selected from Saccharomyces spp. such as S. cerevisiae and S. uvarum, including natural or artificially produced variants of these organisms. The methods for fermentation of wort for production of beer are well known to the person skilled in the arts.

The process of the invention may include adding silica hydrogel to the fermented wort to increase the colloidal stability of the beer. The processes may further include adding kieselguhr to the fermented wort and filtering to render the beer bright.

According to an aspect of the invention is provided beer produced from the wort of the second or third aspect, such as a beer produced by fermenting the wort to produce a beer. The beer may be any type of beer, e.g., ales, strong ales, stouts, porters, lagers, bitters, export beers, malt liquors, happoushu, high-alcohol beer, low-alcohol beer, low-calorie beer or light beer.

### EXAMPLES

### Pullulanase Activity (PUN)

One pullulanase unit (PUN) is defined as the amount of enzyme, which is capable of forming 1 micromole glucose from pullulan substrate per minute at 50° C. in a pH 5 citrate buffer.

Pullulanase samples are incubated with substrate (red pullulan). Endo-pullulanase hydrolyses the alpha-1,6-glycosidic bonds in pullulan, releasing substrate degradation products. Non-degraded substrate is precipitated using ethanol. The amount of color released is measured spectrophotometrically at 510 nm and is proportional to the endo-pullulanase activity in the sample. The color formation of samples is compared to the color formation produced by samples with known pullulanase activity.

Pullulanase is a pullulan 6-glucano-hydrolase with the enzyme classification number E.C.3.2.1.41.

### Reaction Conditions

| | |
|---|---|
| Temperature | 50° C. ± 2° C. |
| pH | 5.0 |
| Substrate concentration | 0.67% red pullulan |
| Enzyme concentration | 0.04-0.13 PUN/ml |
| Reaction time | 30 min. |
| Wavelength | 510 nm |

### Reagents/Substrates

Potassium chloride solution 0.5 M
Pullulan substrate 2%. Supplier Megazyme, Australia
Citrate buffer 0.05 M pH 5.0
Citrate buffer 0.05 M pH 5.0 with 25 mM cysteine

### Ethanol 99.8%

Pullulanase Standard preparation of 904 PUN/g diluted into citrate buffer 0.05 M to a standard dilution series from 0.05-0.20 PUN/ml
Blank Citrate buffer 0.05 M

Enzyme samples are diluted in citrate buffer 0.05 M to an activity between 0.06-0.20 PUN/ml and compared to the standard dilution series.

### Example 1

In this example the sugar profile of a shortened mashing regime was investigated after 15 min and 30 min at 64° C. and after 15 min at 78° C. Heating from 64° C. to 78° C. was done at 1° C./min thus in this case the mash was heated within 14 minutes. The total mashing time was in this case 30 min rest at 64° C.+heating to 78° C. for 14 minutes+15 minutes rest at 78° C. which is 59 minutes in total mashing time.

100% well modified malt was used and the enzyme used is a pullulanase with SEQ ID NO 1.

The pullulanase used in this example is the pullulanase with SEQ ID NO 1, which was added at t=0 minutes (start of mashing) at the concentration indicated below.

### Mashing Profile and Sample Collection:

| | | |
|---|---|---|
| Temperature (° C.) | 64° C. | 78° C. |
| Time (min) | 0-30 min | 30-45 min |
| Sample | Sample 1, 4, 7, 10 | Sample 3, 6, 9, 12 |
| collection | after 15 min | after 45 min |
| | Sample 2, 5, 8, 11 | |
| | after 30 min | |

### Enzyme Dosage:

| | Cup | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| PUN/g | — | — | — | 1.0 | 1.0 | 1.0 | 0.5 | 0.5 | 0.5 | 0.1 | 0.1 | 0.1 |
| DM | | | | | | | | | | | | |

TABLE 2
Total sugar content of the wort samples.

| Total sugar (g/L) | Enzyme (PUN/g DM) | |
|---|---|---|
| 130.10 | Blank | |
| 130.47 | 1 | PUN |
| 131.18 | 0.5 | PUN |
| 130.71 | 0.1 | PUN |

The total amount of fermentable sugars was the same in all samples (78° C./45 min) (Table 2).

Table 3 shows that the sugar profile of a very short mashing profile can be enhanced by use of a pullulanase in the dosage 0.5 and 1 PUN/g dm. A clear dose response of pullulanase is obtained which can be used as a tool to stir the final attenuation.

The fraction of fermentable sugars in the wort sample collected after termination of the mashing regime was improved by 8.6% (1 PUN/g DM) and 4.9% (0.5 PUN/g DM), last column table 3.

TABLE 3
Fermentable and non-fermentable sugars in a short mashing process

| | 64° C./15 minutes | | | | 64° C./30 minutes | | | | 78° C./15 minutes | | | |
|---|---|---|---|---|---|---|---|---|---|---|---|---|
| DP4 | 23.0 | 15.6 | 17.9 | 20.1 | 21.8 | 13.3 | 16.0 | 19.7 | 22.8 | 14.2 | 17.9 | 21.1 |
| DP3 | 11.7 | 14.5 | 13.7 | 11.5 | 12.1 | 14.9 | 14.1 | 12.6 | 12.4 | 14.6 | 14.4 | 12.7 |
| DP2 | 55.7 | 60.6 | 58.4 | 54.0 | 56.3 | 61.9 | 60.1 | 57.3 | 55.2 | 59.5 | 58.4 | 54.8 |
| DP1 | 9.6 | 10.1 | 10.5 | 9.9 | 9.8 | 10.1 | 10.6 | 10.8 | 9.6 | 9.4 | 10.0 | 9.7 |
| | Blank | 1 | 0.5 | 0.1 | Blank | 1 | 0.5 | 0.1 | Blank | 1 | 0.5 | 0.1 |
| | | PUN | PUN | PUN | | PUN | PUN | PUN | | PUN | PUN | PUN |

Abbreviations:
DP degree of polymerization, DP1: glucose, DP2: maltose, DP3: maltotriose, DP4: unfermentable sugars, such as dextrins.
PUN: pullulanase unit
Blank: No enzyme added.

The values are in percent DP's of total DP of the soluble carbohydrates.

Table 3 shows the sugar profile of a very short mashing process. The pullulanase enzyme is added to the mixture of grist and water wherein the mixture has a temperature of 64° C., resting the mixture for 30 min and taking samples at both 15 and 30 minutes. Heating the solution by 1° C./min to 78° C., resting the mixture for 15 minutes at 78° C. and taking a sample after 15 minutes.

Table 3 shows that when the pullulanase is added in 1 and 0.5 PUN the amount of fermentable sugars at 64° C. after 15 min and 64° C. after 30 min and at 78° C. after 15 minutes is at least 80%. Thus it was surprisingly shown that adding an enzyme according to the invention reducing the mashing time and produces a wort with high amount of fermentable sugars e.g. DP1-3.

1. A process for producing a wort comprising the steps of
a) mixing a grist with water,
b) adding a debranching enzyme, wherein said debranching enzyme has above 60% enzyme activity, at 64° C., for a period of 10 minutes, at pH 5.0,
c) resting said mixture at 58-68° C. for a period of 10-40 minutes,
d) resting said mixture at 72-80° C., for a period of 5-20 minutes, and
e) separating the wort from solid components.

2. The process according to claim 1, wherein the temperature is increased from step c) to step d) within 20 minutes.

3. The process according to claim 1, wherein the grist comprises at least 50% malt.

4. The process according to claim 1, wherein the amount of fermentable sugar in the wort is more than 75% of the soluble carbohydrates.

5. The process according to claim 1, wherein steps b)-d) are completed within 30-70 minutes.

6. The process according to claim 1, wherein the debranching enzyme is a pullulanase.

7. The process according to claim 1, wherein the pullulanase is derived from Bacillus.

8. The process according to claim 1, wherein the pullulanase has an amino acid sequence which is at least 80% identical to SEQ ID NO 1.

9. The process according to claim 1, wherein the malt is barley malt.

10. The process according to claim 1, wherein the amount of fermentable sugar in the wort is higher than 80% of the soluble carbohydrates.

11. The process according to claim 1, wherein the ratio of maltose:glucose in the wort is higher than 2:1

12. A process of producing beer comprising producing a wort according to claim 1 and fermenting the wort.

13. The process according to claim 1, wherein the pullulanase has an amino acid sequence which is at least 90% identical to SEQ ID NO: 1.

14. The process according to claim 1, wherein the pullulanase has an amino acid sequence which is at least 95% identical to SEQ ID NO: 1.

15. The process according to claim 1, wherein the pullulanase has an amino acid sequence which is at least 96% identical to SEQ ID NO: 1.

16. The process according to claim 1, wherein the pullulanase has an amino acid sequence which is at least 97% identical to SEQ ID NO: 1.

17. The process according to claim 1, wherein the pullulanase has an amino acid sequence which is at least 98% identical to SEQ ID NO: 1.

18. The process according to claim 1, wherein the pullulanase has an amino acid sequence which is at least 99% identical to SEQ ID NO: 1.
